(19) United States
(12) Patent Application Publication
(10) Pub. No.: US 2009/0013901 A1
(43) Pub. Date: Jan. 15, 2009

(54) ACTIVE ENERGY BEAM-CURABLE INK

(75) Inventors: Keisuke ASADA, Shibata-gun (JP); Koji Nagai, Shibata-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 12/169,341

(22) Filed: Jul. 8, 2008

(30) Foreign Application Priority Data
Jul. 9, 2007 (JP) 2007-180096
Apr. 23, 2008 (JP) 2008-113031

(51) Int. Cl. C09D 11/02; C08K 3/36

(52) U.S. Cl. 106/31.13; 524/847

(57) ABSTRACT

Provided is an active energy beam-curable ink capable of preventing ink flow by enhancing the separation resistance of the ink components at high temperatures without impairing the stability against viscosity changes due to high temperatures. The active energy beam-curable ink contains hydrophilic silica with a primary particle diameter of 100 nm or less. It is preferable that a specific surface of the hydrophilic silica be 280 m²/g or less. It is more preferable that the primary particle diameter and the specific surface of the hydrophilic silica be 28 nm or less and 190 m²/g or less, respectively. Moreover, the ink preferably contains a monomer having ethylene oxide units. The number of ethylene oxide units is preferably 6 to 19. The monomer content is preferably 0.02% by mass to 20% by mass with respect to the total mass of the ink.

### BACKGROUND OF THE INVENTION

1. Field of the Invention

The present invention relates to an active energy beam-curable ink capable of preventing ink flow by enhancing the separation resistance of the ink components at high temperatures without impairing the stability against viscosity changes due to high temperature.

2. Description of the Related Art

In stencil printing, an image is formed by an ink passed through holes of a stencil perforated by thermal digital plate making. In stencil printing emulsion inks have been conventionally used as stencil inks which are, however, slow to dry. Thus, offsets occurs when a printed sheet has many solid parts. Specifically, when printed sheets are stacked on top of each other, the ink on one printed sheet adheres to the other printed sheet, smearing the printed sheet.

To overcome this problem ultraviolet curable inks have been replacing conventional emulsion inks. The ultraviolet curable ink is instantly cured when irradiated with ultraviolet rays. Thus, when such a ultraviolet curable ink is employed for printing, it dries quicker than common W/O (water-in-oil) emulsion inks and thus causes no offset.

Various suggestions have been proposed as to ultraviolet curable inks for stencil printing. For example, an ultraviolet curable ink has been proposed that contains an ultraviolet curable resin as its main component and an organic bentonite as an extending pigment (refer to Japanese Patent (JP-B) No. 2660000). However, when an ink contains an ultraviolet curable resin like this proposed ink, the viscosity changes greatly depends on the temperature change of the ink since the resin is highly temperature dependent, leading to formation of faded images at low temperatures and sheet feed failure at high temperatures. Moreover, when an ink contains organic bentonite as an extending pigment like this proposed ink, each ink component is separated when stored at high temperatures.

An ultraviolet curable emulsion ink has been proposed that prevents temperature-dependent viscosity changes (Japanese Patent Application Laid-Open (JP-A) No. 09-20876). In this proposal, it is possible to keep the temperature-dependent viscosity changes at the same level as conventional emulsion stencil inks. However, when the ink is stored at high temperatures in a printer, it loses its water content by evaporation thus the viscosity changes, resulting in ink component separation.

In addition, when the above ultraviolet curable ink is used, unwanted ink flow occurs in the printer at a normally used temperature. Accordingly, good printed sheet are not successfully obtained when it is used again. Moreover, the ink flow becomes large when the ink is stored at high temperatures.

Therefore, as of now, it is desirable to develop an active energy beam-curable stencil ink capable of preventing ink flow by enhancing the separation resistance of the ink components at high temperatures without impairing the stability against viscosity changes due to high temperatures.

### BRIEF SUMMARY OF THE INVENTION

The present invention has been made in light of the present situation to overcome the conventional problems and to achieve the following object. An object of the present invention is to provide an active energy beam-curable ink capable of preventing ink flow by enhancing the separation resistance of the ink components at high temperatures without impairing the stability against viscosity changes due to high temperatures.

Means for overcoming the problems are as follows:
<1> An active energy beam-curable ink including hydrophilic silica with a primary particle diameter of 100 nm or less.
<2> The active energy beam-curable ink according to <1>, wherein a specific surface of the hydrophilic silica is 280 m²/g or less.
<3> The active energy beam-curable ink according to any one of <1> and <2>, wherein the hydrophilic silica has a primary particle diameter of 28 nm or less and a specific surface of 190 m²/g or less.
<4> The active energy beam-curable ink according to any one of <1> to <3> further including a monomer comprising an ethylene oxide unit represented by Structural Formula (1).

—(CH₂CH₂O)— Structural Formula (1)
<5> The active energy beam-curable ink according to <4>, wherein in the monomer the number of the ethylene oxide unit represented by Structural Formula (1) is 6 to 19.
<6> The active energy beam-curable ink according to any one of <4> and <5>, wherein an amount of the monomer comprising an ethylene oxide unit represented by Structural Formula (1) is 0.02% by mass to 20% by mass with respect to a total mass of the ink.
<7> The active energy beam-curable ink according to any one of <1> to <6>, wherein an amount of water is 5% by mass or less with respect to a total amount of the ink.
<8> The active energy beam-curable ink according to <1> to <7>, wherein the ink is used for stencil printing in which an image is formed by the ink passed through holes of a stencil perforated by thermal digital plate making.
<9> The active energy beam-curable ink according to any one of <1> to <8>, wherein when the ink comprises a monomer comprising an ethylene oxide unit, the monomer is a methacrylate monomer.

According to the present invention, it is possible to overcome the conventional problems and provide an active energy beam-curable ink capable of preventing ink flow by enhancing the separation resistance of the ink components at high temperatures without impairing the stability against viscosity changes due to high temperatures.

### DETAILED DESCRIPTION OF THE INVENTION

### (Active Energy Beam-Curable Ink)

An active energy beam-curable ink (hereinafter, may be referred to as an “ink”) of the present invention includes an extending pigment, an active energy beam-curable polymerizable component, a colorant, a dispersant, and a polymerization initiator. The ink may further include other component(s) such as a polymerization inhibitor, a vegetable oil, an antioxidant, and/or a synergist as necessary.

As used herein the term “active energy beam cure” or “active energy beam curable” means that a polymerizable component is polymerized and cured by irradiation with active energy beams. This can be confirmed by, for example, touching an ink after the active energy beam irradiation. Examples of the active energy beam include ultraviolet rays and electron beams.

The ink of the present invention may be made of material curable by radical polymerization or material curable by cationic polymerization.

### <Extending Pigment>

The extending pigment is at least hydrophilic silica. Where necessary, the extending pigment may further include hydrophobic silica and/or an extending pigment other than the hydrophilic silica and hydrophobic silica.

### —Hydrophilic Silica—

The hydrophilic silica has OH groups on its surface.

The hydrophilic silica is not particularly limited and can be appropriately selected according to purposes. Examples of the hydrophilic silica include AEROSIL 50, AEROSIL 90G, AEROSIL 130, AEROSIL 200, AEROSIL 300, AEROSIL 380, AEROSIL TT600, and AEROSIL COK84 (manufactured by NIPPON AEROSIL CO., LTD). These hydrophilic silicas may be used alone or in combination.

By adding the hydrophilic silica to the ink, it is possible to enhance the separation resistance of the ink components at high temperatures.

The primary particle diameter of the hydrophilic silica is not particularly limited and can be appropriately selected according to purposes. The primary particle diameter is preferably 100 nm or less and more preferably 28 nm or less. When the primary particle diameter is 100 nm or less, it is possible to give film strength and to prevent ink flow in a printer at a normally used temperature. Thus, it is possible to prevent ink flow in a printer when it is stored at high temperatures.

As used herein, the “primary particles” means particles which are in contact with each other at their surfaces or edges and cannot be further dispersed. The “primary particle diameter” can be measured with a transmission electron microscope (TEM).

The “normally used temperature” is from 10° C. to 30° C., and the “high temperatures” for the ink storage is from 50° C. to 70° C.

The specific surface of the hydrophilic silica is not particularly limited and can be appropriately selected according to purposes. The specific surface is preferably 280 m²/g or less, more preferably 250 m²/g or less, and still more preferably from 70 m²/g to 190 m²/g. When the specific surface is 280 m²/g or less, it is possible to prevent the ink dripping in a printer at a normally used temperature. When the specific surface is 70 m²/g or more, it is possible to enhance the separation resistance of the ink components at high temperatures.

Herein, the “specific surface” means a surface area per 1 g.

The specific surface can be measured by BET.

When the primary particle diameter is 28 nm or less and the specific surface is 190 m²/g or less, the separation resistance at high temperatures is further enhanced. Thus, it is possible to prevent ink flow in a printer at a normally used temperature, thereby preventing plate blocking.

The amount of hydrophilic silica is not particularly limited and can be appropriately selected according to purposes. The amount is preferably from 0.5% by mass to 20% by mass and more preferably from 1% by mass to 10% by mass with respect to the total mass of the ink. When the amount is less than 0.5% by mass, a yield value of the ink cannot be increased, and the ink dripping may not be prevented. When the amount exceeds 20% by mass, the yield value may become so high that the ink loses its fluidity.

As used herein, the “yield value” means a “minimum value of shear force required to cause a flow.” When the yield value of the ink is high, the shape of the ink, when left to stand without being given an external force, is stabilized. Thus, it is possible to prevent ink flow.

### —Hydrophobic Silica—

The hydrophobic silica is prepared by substituting hydrophobic groups such as methyl groups for approximately 80% of OH groups on the surface of the hydrophilic silica.

The hydrophobic silica is not particularly limited and can be appropriately selected according to purposes. Examples of the hydrophobic silica include AEROSIL R972, AEROSIL R974, AEROSIL R202, AEROSIL R805, AEROSIL R812, AEROSIL R812S, AEROSIL RX200, and AEROSIL RY200 (manufactured by NIPPON AEROSIL CO., LTD).

The hydrophobic silica may be used alone or in combination.

When the hydrophilic silica and the hydrophobic silica are used in combination, it is possible to give plastic viscosity to the ink without impairing the temperature characteristics of the hydrophilic silica. Thus, it is possible to enhance the separation resistance at high temperatures.

The specific surface of the hydrophobic silica is not particularly limited and can be appropriately selected according to purposes. The specific surface is preferably from 70 m²/g to 300 m²/g, more preferably from 70 m²/g to 200 m²/g, and still more preferably from 70 m²/g to 150 m²/g.

The amount of hydrophobic silica is not particularly limited and can be appropriately selected according to purposes. The amount is preferably from 0.5% by mass to 20% by mass and more preferably from 1% by mass to 10% by mass with respect to the total mass of the ink. When the amount is less than 0.5% by mass, the plastic viscosity may become extremely low. When the amount exceeds 20% by mass, the plastic viscosity may become so high that the ink loses its fluidity.

—Extending Pigments other than Hydrophilic Silica and Hydrophobic Silica—

The extending pigment other than the hydrophilic silica and the hydrophobic silica are not particularly limited and can be appropriately selected according to purposes. Examples of the extending pigment include: fine inorganic particles composed of organic bentonite, white clay, talc, clay, calcium carbonate, barium sulfate, titanium oxide, alumina white, diatomaceous earth, kaolin, mica, aluminum hydroxide, and the like; fine organic particles composed of polyacrylate ester, polyurethane, polyester, polyethylene, polypropylene, polyvinylchloride, polyvinylidene chloride, polystyrene, polysiloxane, phenol resin, epoxy resin, and the like; and fine particles composed of copolymers of these compounds.

These extending pigments other than the hydrophilic silica and the hydrophobic silica may be used alone or in combination.

The amount of extending pigments other than the hydrophilic silica and the hydrophobic silica is not particularly limited and can be appropriately selected according to purposes. The amount is preferably from 0.1% by mass to 50% by mass, more preferably from 1% by mass to 15% by mass, and still more preferably from 2% by mass to 5% by mass with respect to the total mass of the ink.

### <Polymerizable Component>

The active energy beam-curable polymerizable components is at least a monomer having in its molecule a unit represented by Structural Formula (1). The polymerizable component may further include other polymerizable component(s) as necessary. The unit represented by Structural Formula (1) is an ethylene oxide (EO) unit.

—(CH₂CH₂O)— Structural Formula (1)

### —Monomer Having Ethylene Oxide Unit—

The monomer having the ethylene oxide unit is not particularly limited and can be appropriately selected according to purposes. Examples of the monomer include triethylene glycol di(meth)acrylate, tetraethylene glycol di(meth)acrylate (the number of ethylene oxide units is from 5 to 20), and ethylene oxide-modified trimethylol tri(meth)acrylate (the number of ethylene oxide units is from 3 to 20). The methacrylate monomers are preferable for the monomer having the ethylene oxide units in view of skin irritation and skin sensitivity

Commercially available products can be used as the monomer having the ethylene oxide units. Example of the products include: ARONIX series (M-102, M-113, M-120, M-210, M-240, M-243, M-245, M-260, M-350, and M-360) manufactured by Toagosei Co., Ltd.; series (SR504, CD614, CD9087, CD550, CD552, SR230, SR259, SR268, SR273, SR344, SR349, CD560, CD561, CD564, SR601, SR602, SR610, CD9043, SR9045, SR9029, SR205, SR209, SR210, SR231, SR252, SR348, SR480, CD540, CD541, CD542, SR603, SR9036, SR415, SR454, SR499, SR502, SR9035, and SR494) manufactured by Sartomer Company Inc; NEW FRONTIER series (PHE-2, PHE-4, CEA, NP-4, N-177E, ME-3, ME-4S, EH-2, PE-200, PE-300, PE-400, PE-600, BPE-4, BPE-10, BPE-20, HBPE-4, MPEM-400, MPEM-1000, TEGDMA, PEM-1000, and BPEM-10) manufactured by Dai-Ichi Kogyo Seiyaku Co., Ltd.; LIGHT-ESTER series (BC, MTG, 130MA, 041MA, 2EG, 3EG, 4EG, 9EG, 14EG, BP-2EM, BP-4EM, and BP-6EM) and LIGHT-ACRYLATE series (EC-A, MTG-A, EHDG-A, 130A, P-200A, NP-4EA, NP-8EA, 3EG-A, 4EG-A, 9EG-A, 14EG-A, BP-4EA, BP-10EA, TMP-3EO-A, and TMP-6EO-3A) manufactured by Kyoeisha Chemical Co., Ltd.; EBERCRYL series (PEG300DA, PEG400DA, 11, 160, TMPEOTA, and 40) manufactured by DAICEL-CYTEC company Ltd.; and BLENMER series (PE-90, PE-200, PE-350, AE-90, AE-200, AE-400, 50PEP-300, 70PEP-350B, AEP series, 55PET-400, 30PET-800, 55PET-800, AET series, PME-100, PME-200, PME-350, PME-400, PME-550, PME-1000, PME-4000, AME-400, AEE-100, 50POEP-800B, 50AOEP-800B, PLE-200, ALE-200, ALE-800, PSE-200, PSE-400, PSE-1300, ASEP series, PKEP series, AKEP series, ANE, 43ANEP-500, 70ANEP-550, 75ANEP-600, AAE-300, PDE-100, PDE-150, PDE-200, PDE-400, PDE-600, PDE-1000, ADE-200, ADE-400, PDET series, 50ADET-1800, 30PDC-800B, 30PDC-950B, 20PDC-1300B, 40PDC-1700B, 30ADC-900B, PDBE-200, PDBE-250, PDBE-450, PDBE-1300, ADBE-200, ADBE-250, ADBE-450, PDBEP series, ADBEP series, and 43PDBPE-800B) manufactured by NOF Corporation.

By adding the monomer having the ethylene oxide units to the ink, it is possible to prevent the ink dripping in a printer when the ink is stored at high temperatures. Thus, the viscosity stability of the ink when stored at high temperatures can be further enhanced.

It is preferable that the monomer having the ethylene oxide units do not have a benzene ring or a bisphenol A skeleton in its molecular structure.

The number of the ethylene oxide unit in the above monomers is not particularly limited and can be appropriately selected according to purposes. The number is preferably from 6 to 19, more preferably from 6 to 14, and still more preferably from 7 to 10. In the case where the number of the ethylene oxide unit is 6 or more, it is possible to prevent ink flow in a printer when the ink is stored at high temperatures. When the number of ethylene oxide units is 19 or less, it is possible to prevent ink flow in a printer at a normally used temperature.

The amount of monomer having the ethylene oxide unit is preferably 0.02% by mass to 20% by mass, more preferably 0.2% by mass to 10% by mass, and still more preferably 0.2% by mass to 5% by mass with respect to the total mass of the ink. When the amount is 0.02% by mass to 20% by mass, it is possible to enhance the viscosity stability upon storage at high temperatures.

The monomer having the ethylene oxide unit is preferably water-soluble and preferably used in combination with a monomer that is insoluble in water. Moreover, it is particularly preferable that the monomer having the ethylene oxide unit be used in combination with a caprolactone-modified monomer such as caprolactone-modified dipentaerythritol hexacrylate or caprolactone-modified hydroxypivalate ester neopentyl glycol.

That the molecule in the ink contains the monomer having the unit represented by Structural Formula (1) and the specific structure thereof can be analyzed based on the formula and composition ratio as follows: polymerizable components are extracted from the obtained ink by, for example, centrifugation or Soxhlet extraction; and the extract is concentrated and subjected to gas chromatography, liquid chromatography, Fourier-transform infrared spectroscopy (FT-IR), nuclear magnetic resonance (NMR) spectroscopy, elementary analysis, mass spectroscopy, or the like.

### —Other Polymerizable Components—

The active energy beam-curable polymerizable component may include other polymerizable component(s) which do not contain the unit represented by Structural Formula (1) in its molecule.

Examples of the other polymerizable components include urethane-, epoxy-, or polyester-based polyol acrylic acid-modified or methacrylic acid-modified monomers/oligomers.

Examples of the monomers in the other polymerizable components include monofunctional and polyfunctional acrylate and methacrylate monomers (hereinafter, both of the monomers may be generically referred to as (meth)acrylate). The methacrylate monomers are more preferable for skin irritation and skin sensitivity. Specific examples of the monofunctional (meth)acrylate monomers include dicyclopentyl ethyl(meth)acrylate, isobonyl(meth)acrylate, and phenol ethylene oxide-modified (meth)acrylate. Examples of the bifunctional (meth)acrylate monomers include tripropylene glycol di(meth)acrylate, caprolactone-modified hydroxypivalate ester neopentyl glycol, 1,6-hexanediol di(meth)acrylate, bisphenol A diglycidyl ether di(meth)acrylate, polypropylene glycol di(meth)acrylate (the number of propylene oxide units is from 3 to 14), polytetramethyleneglycol di(meth)acrylate (PO: 3 to 14), 1,4-butanediol di(meth)acrylate, and neopentylglycol di(meth)acrylate. Examples of the trifunctional (meth)acrylate monomers include trimethylolpropane tri(meth)acrylate, pentaerythritol tri(meth)acrylate, propylene oxide-modified glycerol tri(meth)acrylate, and propylene oxide (PO)-modified trimethylolpropane tri(meth)acrylate (the number of propylene oxide units is from 1 to 6). Examples of the tetra- or more functional (meth)acrylate monomers include pentaerythritol tetra(meth)acrylate, ditrimethylolpropane tetra(meth)acrylate, pentaerythritol ethoxytetra(meth)acrylate, dipentaerythritol hexa(meth)acrylate, and caprolactone-modified dipentaerythritol hexa(meth)acrylate.

Commercially available products may be used for the monomer in the other polymerizable components. Besides the aforementioned monomers, monomers available from Toagosei Co., Ltd., Sartomer Company Inc, Kyoeisha Chemical Co., Ltd., Nippon Kayaku Co., Ltd., Dai-Ichi Kogyo Seiyaku Co., Ltd., DAICEL-CYTEC company Ltd., NOF Corporation, Shin-Nakamura Chemical Co., Ltd., BASF company, Nippon Synthetic Chemical Industry Co., Ltd., Asahi Denka Industry Co., Ltd., Arakawa Chemical Industries, Ltd., and the like may be used.

It is preferable that the monomer in the other polymerizable components do not have a benzene ring or a bisphenol A skeleton in its molecular structure.

Examples of the oligomers include epoxy acrylates, epoxidized oil acrylates, urethane acrylates, unsaturated polyesters, polyester acrylates, and vinyl acrylates.

These other polymerizable components may be used alone or in combination.

The viscosity of the other polymerizable components is not particularly limited and can be appropriately selected according to purposes. The viscosity is preferably 1.5 Pa·s or less and more preferably 0.3 Pa·s or less at 25° C. to reduce a viscosity change due to the temperature. To prevent degradation of image quality due to insufficient ink fluidity, the viscosity is preferably 0.02 Pa·s or more and more preferably 0.1 Pa·s or more.

### <Colorant>

The colorant is not particularly limited, and insoluble colorants such as known pigments and disperse dyes of various colors can be used.

Examples of the colorant include: carbon blacks such as acetylene black, channel black, and furnace black; metal powders such as aluminum powder and bronze powder; inorganic pigments such as red oxide, chrome yellow, ultramarine blue, chromium oxide, and titanium oxide; azo pigments such as insoluble azo pigment, azolake pigment, and condensed azo pigment; phthalocyanine pigments such as metal-free phthalocyanine pigment and copper phthalocyanine pigment; condensed polycyclic pigments such as anthraquinone dye, quinacridon dye, isoindolinone dye, isoindoline dye, dioxazine dye, threne dye, perylene dye, perynone dye, thioindigo dye, quinophthalone dye, and metal complex; organic pigments such as lakes of acidic or basic dyes; oil-soluble dyes such as diazo dye and anthraquinone dye; and fluorescent pigments.

The above-stated fluorescent pigment is preferably a synthetic resin solid solution which can be obtained as follows: fluorescent dyes of various colors are dissolved in a synthetic resin or the resin is dyed with the fluorescent dyes when the synthetic resin is subjected to bulk polymerization or after the synthetic resin is polymerized; and the colored mass resin is pulverized into fine particles. Examples of the synthetic resin bearing the dyes include melamine resins, urea resins, sulfonamide resins, alkyd resins, and polyvinylchloride resins.

Commercially available products may be used for the colorant. Examples of commercially available carbon blacks include MA-100, MA-100S, MA-7, MA-70, MA-77, MA-11, #1000, #40, and #44 (manufactured by Mitsubishi Chemical Corporation); Raven1100, Raven1080, Raven1255, Raven760, and Raven410 (manufactured by Columbia Carbon Company); and MOGUL-L, MOGUL-E, and PEARLS-E (manufactured by CABOT JAPAN K.K.).

These colorants may be used alone or in combination.

The colorant is dispersed in the ink. The average particle diameter of the dispersed colorant in the ink is not particularly limited and can be appropriately selected according to purposes. The average particle diameter is preferably from 0.1 μm to 10 μm and more preferably from 0.1 μm to 1.0 μm. When the average particle diameter is less than 0.1 μm, the pigments infiltrate into paper immediately after the printing, and desired image density may not be obtained. When the average particle diameter is exceeds 10 μm, the stability of the ink may be degraded.

An amount of colorant is not particularly limited and can be selected according to purposes. In general, the amount is preferably from 2% by mass to 15% by mass with respect to the total mass of the ink.

### <Colorant Dispersant>

A colorant dispersant is a component which disperses the colorant and the extending pigment.

The colorant dispersant is not particularly limited and can be appropriately selected according to purposes. Examples of the colorant dispersant include: nonionic surfactants such as sorbitan fatty acid esters (e.g., sorbitansesquioleate), polyglycerin fatty acid esters (e.g., hexaglycerin polyricinoleate), polyoxyethylene, glycerin fatty acid ester, polyoxyethylene sorbitan fatty acid ester, polyoxyethylene alkyl ether, polyoxyethylene alkylamine fatty acid amide; high molecular compounds of alkylamines; compounds of aluminum chelates; copolymerized high molecular compounds of styrene-maleic anhydrides; high molecular compounds of polycarboxylic acid esters; aliphatic polyhydric carboxylic acids; amine salts of high molecular polyesters; ester anionic surfactants; long-chain amine salts of high molecular weight polycarboxylic acids; a salt of long-chain polyamino amides and polyacidic polyesters; compounds of polyamides; phosphoric acid ester surfactants; salts of alkyl sulfo-carboxylic acids; sulfonates; α-olefin sulfonates; dioctyl sulfosuccinates; polyethyleneimine; alkylolamine salts; and resins such as alkyd resins having a function of dispersing insoluble colorants.

Commercially available products can be used for the colorant dispersants. Examples of the commercially available products include SOLUSPHASE series (e.g., S3000, S5000, S9000, S13240, S13940, S16000, S17000, S20000, S24000, S26000, S27000, S28000, S31845, S31850, S32000, S32550, S34750, S39000, S41090, and S53095) manufactured by Lubrizol Japan Ltd.; PLANE-ACT AL-M and AJISPER series (e.g., PB711, PM821, PB821, PB811, PN411, and PA111) manufactured by Ajinomoto Fine-Techno Co., Inc.; and TMGS-15, TMGO-15, Decaglyn series (e.g., 1-L, 1-M, and 1-0), TL-10, TP-10, TO-10, TI-10, BL-21, BC-15TX, BC-23, BC-30TX, BC-40TX, BS-20, BO-1OTX, TAMNS-10, TAMNS-15, TAMNO-5, TAMNO-15, TDMNS-8, OTP-100, and OTP-75 manufactured by Nikko Chemicals, Co., Ltd. These colorant dispersants may be used alone or in combination.

The amount of colorant dispersant is not particularly limited and can be appropriately selected according to purposes. The amount is preferably 40% by mass or less and more preferably from 2% by mass to 35% by mass with respect to the total mass of the colorant and the extending pigment.

### <Polymerization Initiator>

The polymerization initiator is not particularly limited and can be appropriately selected according to purposes. Examples of the polymerization initiator include radical polymerization initiators such as photocleavable initiators and hydrogen abstraction initiators. Examples of such initiators include benzophenone, acetophenone, 4,4′-bisdiethylamino benzophenone, benzoin, and benzoin ethyl ether.

Commercially available products may be used for the polymerization initiator. Examples of the commercially available products include: IRGACURE series (651, 184, 907, 369, 379, and 819) and DAROCUR series (MBF, TPO, and 1173) manufactured by Ciba Specialty Chemicals K.K.; and KAYACURE series (MBS, DETX-S, ITX, and CTX) manufactured by Nippon Kayaku Co., Ltd.

These polymerization initiators may be used alone or in combination depending on a light source to be employed.

The polymerization initiator may be used in combination with a sensitizer or a polymerization promoter. Examples of such agents include aliphatic amines and aromatic amines such as n-butylamine, triethylamine, and p-dimethylamine ethyl benzoate. Specific examples of such agents include DAROCUR EDB and DAROCUR EHA (manufactured by Ciba Specialty Chemicals K.K.); and KAYACURE EPA and KAYACURE DMBI (manufactured by Nippon Kayaku Co., Ltd.).

The amounts of polymerization initiator, sensitizer, and polymerization promoter are not particularly limited and can be appropriately selected according to purposes as long as the effects of the present invention are exerted. The amount of each of these agents is preferably from 1% by mass to 25% by mass and more preferably 1% by mass to 15% with respect to the total mass of the ink.

### <Other Components>

Other components in the ink of the present invention are not particularly limited and can be appropriately selected according to purposes as long as the effects of the present invention are exerted. Examples of the other components include a polymerization inhibitor, vegetable oil, an antioxidant, and a synergist.

### —Polymerization Inhibitor—

A polymerization inhibitor may be used for the ink of the present invention to ensure storage stability of the ink and prevent gelation due to dark reaction.

The polymerization inhibitor is not particularly limited and can be appropriately selected according to purposes. Examples of the polymerization inhibitor include hydroquinone, p-benzoquinone, t-butylhydroquinone, and p-methoxyphenol (MEHQ).

An amount of polymerization inhibitor is not particularly limited and can be appropriately selected according to purposes. In general, the amount is preferably from 100 ppm to 5,000 ppm and more preferably from 100 ppm to 500 ppm with respect to the total mass of the ink.

### —Vegetable Oil—

Vegetable oil may be used for the ink of the present invention as necessary as long as the curing property of the ink is not degraded.

The vegetable oil is not particularly limited and can be appropriately selected according to purposes. Examples of the vegetable oils include soybean oil, rapeseed oil, corn oil, sesame oil, tall oil, cottonseed oil, sunflower oil, safflower oil, walnut oil, poppy oil, and linseed oil.

Moreover, an esterified vegetable oil may be used as the vegetable oil. Examples of the esters include methyl esters, butyl esters, isopropyl esters, and propyl esters. Among these, drying oil and semidrying oil, which have an iodine value of 100 or more, are preferably used to dry the ink after the printing. However, vegetable oil having an iodine value of 100 or less may be used when the ink is left in a printer for a long period of time and ink adhesion occurs.

The vegetable oils may be used alone or in combination.

When a drying oil and/or semidrying oil having a high iodine value are used as the vegetable oil, they react with oxygen in air. This dries (solidifies) the oil, thereby solidifying the ink containing the oil. When the ink is solidified, the screen is blocked and printing speed and image quality are degraded. Thus, when such vegetable oil having a high iodine value (or having a large number of unsaturated bonds) is used, the ink preferably contains the undermentioned antioxidant to prevent oxidization of fatty acids (e.g., linolenic acid, linoleic acid, and oleic acid) in the vegetable oil.

The amount of vegetable oil is not particularly limited and can be appropriately selected according to purposes. The amount is preferably from 5% by mass to 70% by mass and more preferably from 30% by mass to 50% by mass with respect to the total mass of the ink.

### —Antioxidant—

The antioxidant is not particularly limited and can be appropriately selected from known compounds according to purposes. Examples of the antioxidant include: amine compounds such as diphenyl phenylenediamine and isopropylphenyl phenylenediamine; phenol compounds such as tocopherol and dibutylmethylphenol; and sulfur compounds such as mercaptomethyl benzimidazole; dibutylhydroxytoluene; propyl gallate; and butylated hydroxyanisole.

The antioxidants may be used alone or in combination.

The amount of antioxidant is not particularly limited and can be appropriately selected according to purposes. The amount is preferably 2% by mass or less and more preferably from 0.1% by mass to 1.0% by mass with respect to the oil in the ink.

When an extremely small amount of antioxidant is added with respect to the amount of vegetable oil, the antioxidant may not function properly. On the other hand, when an excessive amount of antioxidant is added all at once with respect to the amount of vegetable oil, the antioxidant may act as a prooxidant. Thus, the undermentioned synergist is preferably added to prevent oxidization of the vegetable oil even when a small amount of antioxidant is added.

### —Synergist—

The synergist itself hardly acts as an antioxidant, but enhances the function of the antioxidant when the synergist is used in combination with the antioxidant. The synergist is generally an acidic substance and is a polyfunctional compound having several hydroxyl groups or carboxyl groups.

The synergist is not particularly limited and can be appropriately selected according to purposes. Examples of the synergist include methionine, ascorbic acid, threonine, leucine, protein hydrolysates, norvaline, ascorbyl palmitate, phenylalanine, cysteine, tryptophan, proline, alanine, glutaminic acid, valine, pepsin-digested juice of pancreatic proteins, asparagine, arginine, barbiturate, asphenamine, ninhydrin, propanidine, histidine, norleucine, glycerophosphoric acid, liquid of casein hydrolyzed by trypsin, and liquid of casein hydrolyzed with hydrochloric acid.

The synergists may be used alone or in combination.

Then amount of synergist is not particularly limited and can be appropriately selected according to purposes. The amount is preferably from 50% by mass to 150% by mass with respect to the total mass of the antioxidant.

### <Emulsification>

The ink of the present invention may be in a form of emulsion by adding water and an emulsifier (HLB: 3 to 10).

By adding a small amount of water to the ink, the ink becomes smooth and a printed sheet is smoothly delivered.

The amount of water is not particularly limited and appropriately selected according to purposes. In consideration of the separation resistance of the ink components at high temperatures, the amount is preferably 20% by mass or less and more preferably 5% by mass or less with respect to the total mass of the ink. Still more preferably, the ink does not contain water. When the amount exceeds 20% by mass, the separation resistance is degraded in a printer. When the amount is 5% by mass or less, the separation resistance at high temperatures is enhanced.

The amount of emulsifier is not particularly limited and can be appropriately selected according to purposes. It is preferable that the ink do not contain the emulsifier. When a water-soluble monomer is used as a monomer instead of the monomer having the ethylene oxide unit, the ink can be in a form of emulsion without adding the emulsifier to the ink.

### <Manufacturing Method for Active Energy Beam-Curable Ink>

The manufacturing method for the active energy beam-curable ink of the present invention is not particularly limited and can be appropriately selected from known methods according to purposes. For example, the ink can be obtained by a manufacturing method in which components are mixed by a usual process and dispersed using a dispersion machine such as a three-roll mill.

When the ink is used as a stencil ink, the viscosity of the ink can be adjusted by changing agitation conditions. The viscosity of the ink is not particularly limited as long as the viscosity is suitable to be used in a stencil printing system. The viscosity is preferably from 2 Pa·s to 40 Pa·s and more preferably from 10 Pa·s to 30 Pa·s when the share rate is 20 s⁻¹. Additionally, an approximate value of the plastic viscosity of the ink, obtained by the following Casson's equation, is preferably 2.0 Pa·s or less, more preferably 1.0 Pa·s or less, and still more preferably 0.5 Pa·s or less to prevent curling of a printed sheet. The yield value of the ink, as approximated using the following Casson's Approximation formula, is preferably 25 Pa to 250 Pa and more preferably 25 Pa to 100 Pa.

Casson's Approximation Formula: \sqrt{υ}−\sqrt{τ₀}=\sqrt{Eta×D} Equation (1)

where τ represents a shear stress, τ₀ represents a yield value, Eta represents a plastic viscosity, and D represents a shear velocity.

### EXAMPLES

Hereinafter, Examples of the present invention will be described, which however shall not be construed as limiting the scope of the present invention.

### Examples 1 to 24 and Comparative Examples 1 to 5

### —Preparation of Active Energy Beam-Curable Ink—

A colorant, a colorant dispersant, an extending pigment, a polymerizable component, and a polymerization initiator were mixed according to formulations shown in Tables 1 to 3. The mixture was dispersed using a three-roll mill (manufactured by Inoue Manufacturing Co., Ltd) to prepare active energy beam-curable inks of Examples 1 to 24 and Comparative Examples 1 to 5.

TABLE 1

| | | Com. | Com. | Com. | Com. | Com. | | | | | | |
|---|---|---|---|---|---|---|---|---|---|---|---|---|
| | | Ex. 1 | Ex. 2 | Ex. 3 | Ex. 4 | Ex. 5 | Ex. 1 | Ex. 2 | Ex. 3 | Ex. 4 | Ex. 5 | Ex. 6 |
| Colorant | Carbon Black | 6.0 | 6.0 | 6.0 | 6.0 | 6.0 | 6.0 | 6.0 | 6.0 | 6.0 | 6.0 | 6.0 |
| | (#1000) (1) | | | | | | | | | | | |
| Colorant | Silsperse32000 | 0.2 | 0.2 | 0.2 | 0.2 | 0.2 | 0.2 | 0.2 | 0.2 | 0.2 | 0.2 | 0.2 |
| Dispersant | (2) | | | | | | | | | | | |
| Extending | AerosilR972 | 6.0 | | | | | | | | | | |
| Pigment | Aerosil50 | | | | | | 6.0 | | | | | |
| | Aerosil90G | | | | | | | 6.0 | | | | |
| | Aerosil130 | | | | | | | | 6.0 | | | |
| | Aerosil200 | | | | | | | | | 5.0 | | |
| | Aerosil300 | | | | | | | | | | 5.0 | |
| | Aerosil380 | | | | | | | | | | | 5.0 |
| | AdmafineSO-C1 | | | 20.0 | | 6.0 | | | | | | |
| | Garamite1958 | | 4.0 | | 6.0 | | | | | | | |
| Polymerizable | Light-Ester4EG | | | | | | | | | | | |
| Component | Light-Ester9EG | | | | | | | | | | | |
| (Monomer, | Light-Ester14EG | | | | | | | | | | | |
| Oligomer) | New | | | | | | | | | | | |
| | FrontierPE300 | | | | | | | | | | | |
| | New | | | | | | | | | | | |
| | FrontierPE400 | | | | | | | | | | | |
| | SR9035 | | | | | | | | | | | |
| | SR415 | | | | | | | | | | | |
| | OTA480 | 19.2 | 19.7 | 15.7 | 19.2 | 19.2 | 19.2 | 19.2 | 19.2 | 19.5 | 19.5 | 19.5 |
| | DPCA-60 | 57.6 | 59.1 | 47.1 | 57.6 | 57.6 | 57.6 | 57.6 | 57.6 | 58.3 | 58.3 | 58.3 |
| | CN116 | 1.0 | 1.0 | 1.0 | 1.0 | 1.0 | 1.0 | 1.0 | 1.0 | 1.0 | 1.0 | 1.0 |
| Polymerization | Irugacure184 | 8.0 | 8.0 | 8.0 | 8.0 | 8.0 | 8.0 | 8.0 | 8.0 | 8.0 | 8.0 | 8.0 |
| Initiator (3) | Irugacure379 | 1.0 | 1.0 | 1.0 | 1.0 | 1.0 | 1.0 | 1.0 | 1.0 | 1.0 | 1.0 | 1.0 |
| | Darocure EHA | 1.0 | 1.0 | 1.0 | 1.0 | 1.0 | 1.0 | 1.0 | 1.0 | 1.0 | 1.0 | 1.0 |

| | | | | | | | | | | | |
|---|---|---|---|---|---|---|---|---|---|---|---|
| Water | 0.0 | 0.0 | 0.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 | 100.0 |

(Unit: % by mass)

TABLE 2

| | | Ex. 7 | Ex. 8 | Ex. 9 | Ex. 10 | Ex. 11 | Ex. 12 | Ex. 13 | Ex. 14 |
|---|---|---|---|---|---|---|---|---|---|
| Colorant | Carbon | 6.0 | 6.0 | 6.0 | 6.0 | 6.0 | 6.0 | 6.0 | 6.0 |
| | Black (#1000) (1) | | | | | | | | |
| Colorant | Silsperse32000 (2) | 0.2 | 0.2 | 0.2 | 0.2 | 0.2 | 0.2 | 0.2 | 0.2 |
| Dispersant | | | | | | | | | |
| Extending | AerosilR972 | | | | | | | | |
| Pigment | Aerosil50 | | | | | | | | |
| | Aerosil90G | | | | | | | | |
| | Aerosil130 | 4.0 | 4.0 | 4.0 | 4.0 | 4.0 | 4.0 | 4.0 | 4.0 |
| | Aerosil200 | | | | | | | | |
| | Aerosil300 | | | | | | | | |
| | Aerosil380 | | | | | | | | |
| | AdmafineSO-C1 | | | | | | | | |
| | Garamite1958 | | | | | | | | |
| Polymerizable | Light-Ester4EG | | | | | 2.0 | | | |
| Component | Light-Ester9EG | | | | | 2.0 | | | |
| (Monomer, | Light-Ester14EG | | | | | 2.0 | | | |
| Oligomer) | New FrontierPE300 | | | | | | 4.0 | | |
| | New FrontierPE400 | 21.0 | 4.0 | 1.0 | 0.1 | | | | |
| | SR9035 | | | | | | | 2.0 | |
| | SR415 | | | | | | | | 2.0 |
| | OTA480 | 0.0 | 15.7 | 18.7 | 19.6 | 17.7 | 15.7 | 17.7 | 17.7 |
| | DPCA-60 | 57.8 | 59.1 | 59.1 | 59.1 | 59.1 | 59.1 | 59.1 | 59.1 |
| | CN116 | 1.0 | 1.0 | 1.0 | 1.0 | 1.0 | 1.0 | 1.0 | 1.0 |
| Polymerization | Irugacure184 | 8.0 | 8.0 | 8.0 | 8.0 | 8.0 | 8.0 | 8.0 | 8.0 |
| Initiator (3) | Irugacure379 | 1.0 | 1.0 | 1.0 | 1.0 | 1.0 | 1.0 | 1.0 | 1.0 |
| | Darocure EHA | 1.0 | 1.0 | 1.0 | 1.0 | 1.0 | 1.0 | 1.0 | 1.0 |

| | | | | | | | | |
|---|---|---|---|---|---|---|---|---|
| Water | 0.0 | 0.0 | 0.0 | 0.0 | 0.0 | 0.0 | 0.0 | 0.0 |
| Total | 100.0 | 100.0 | 100.0 | 100.0 | 104.0 | 100.0 | 100.0 | 100.0 |

(Unit: % by mass)

TABLE 3

| | | Ex. 15 | Ex. 16 | Ex. 17 | Ex. 18 | Ex. 19 | Ex. 20 | Ex. 21 | Ex. 22 | Ex. 23 | Ex. 24 |
|---|---|---|---|---|---|---|---|---|---|---|---|
| Colorant | Carbon Black | 6.0 | 6.0 | 6.0 | 6.0 | 6.0 | 6.0 | 6.0 | 6.0 | 6.0 | 6.0 |
| | (#1000) (1) | | | | | | | | | | |
| Colorant | Silsperse32000 | 0.2 | 0.2 | 0.2 | 0.2 | 0.2 | 0.2 | 0.2 | 0.2 | 0.2 | 0.2 |
| Dispersant | (2) | | | | | | | | | | |
| Extending | AerosilR972 | | | | | | | | | | |
| Pigment | Aerosil50 | | | | | | | | | | |
| | Aerosil90G | | | | | | | | | | |
| | Aerosil130 | 4.0 | 4.0 | | 6.0 | 4.0 | 4.0 | 4.0 | 4.0 | 4.0 | 4.0 |
| | Aerosil200 | | | 6.0 | | | | | | | |
| | Aerosil300 | | | | | | | | | | |
| | Aerosil380 | | | | | | | | | | |
| | AdmafineSO-C1 | | | | | | | | | | |
| | Garamite1958 | | | | | | | | | | |
| Polymerizable | Light-Ester4EG | | | | | | | | | | |
| Component | Light-Ester9EG | | | | | | 1.0 | | | | |
| (Monomer, | Light-Ester14EG | | | | | | | 1.0 | | | |
| Oligomer) | New | | | | | 2.0 | | | | | |
| | FrontierPE300 | | | | | | | | | | |
| | New | 19.4 | 18.2 | | 1.0 | | | | 15.0 | 0.02 | 0.005 |
| | FrontierPE400 | | | | | | | | | | |
| | SR9035 | | | | | | | | | | |
| | SR415 | | | | | | | | | | |
| | OTA480 | 0.0 | 0.0 | 19.2 | 18.2 | 17.7 | 18.7 | 18.7 | 0.0 | 19.68 | 19.695 |
| | DPCA-60 | 58.4 | 54.6 | 57.6 | 57.6 | 59.1 | 59.1 | 59.1 | 63.8 | 59.1 | 59.1 |
| | CN116 | 1.0 | 1.0 | 1.0 | 1.0 | 1.0 | 1.0 | 1.0 | 1.0 | 1.0 | 1.0 |
| Polymerization | Irugacure184 | 8.0 | 8.0 | 8.0 | 8.0 | 8.0 | 8.0 | 8.0 | 8.0 | 8.0 | 8.0 |
| Initiator (3) | Irugacure379 | 1.0 | 1.0 | 1.0 | 1.0 | 1.0 | 1.0 | 1.0 | 1.0 | 1.0 | 1.0 |
| | Darocure EHA | 1.0 | 1.0 | 1.0 | 1.0 | 1.0 | 1.0 | 1.0 | 1.0 | 1.0 | 1.0 |

| | | | | | | | | | | |
|---|---|---|---|---|---|---|---|---|---|---|
| Water | 1.0 | 6.0 | 0.0 | 0.0 | 0.0 | 0.0 | 0.0 | 0.0 | 0.0 | 0.0 |
| Total | 100.0 | 100.0 | 100.0 | 100.0 | 100.0 | 100.0 | 100.0 | 100.0 | 100.0 | 100.0 |

(Unit: % by mass)

Compounds represented by the numbers (1) to (3) in Tables 1 to 3 indicate that they are manufactured by Mitsubishi Chemical Corporation, Lubrizol Japan Ltd, and Ciba Specialty Chemicals K.K, respectively. Tables 4 and 5 show details of the extending pigments and polymerizable components in Tables 1 to 3.

TABLE 4

| | | | | Specifc | |
|---|---|---|---|---|---|
| | | | Primary | Surface | |
| | | | Particle | measured | |
| Name Of | Name of | Surface | Diameter | by BET | |
| Product | Manufacturer | Characteristic | (nm) | (m²/g) | Material |
| AerosilR972 | Nippon Aerosil | Hydrophobic | 16 | 110 | Silica |
| | Co., Ltd | | | | |
| Aerosil50 | Nippon Aerosil | Hydrophilic | 30 | 50 | Silica |
| | Co., Ltd | | | | |
| Aerosil90G | Nippon Aerosil | Hydrophilic | 20 | 90 | Silica |
| | Co., Ltd | | | | |
| Aerosil130 | Nippon Aerosil | Hydrophilic | 16 | 130 | Silica |
| | Co., Ltd | | | | |
| Aerosil200 | Nippon Aerosil | Hydrophilic | 12 | 200 | Silica |
| | Co., Ltd | | | | |
| Aerosil300 | Nippon Aerosil | Hydrophilic | 7 | 300 | Silica |
| | Co., Ltd | | | | |
| Aerosil380 | Nippon Aerosil | Hydrophilic | 7 | 380 | Silica |
| | Co., Ltd | | | | |
| AdmafineSO-C1 | Admatechs Co., | Hydrophilic | 250 | 17 | Silica |
| | Ltd | | | | |
| Garamite1958 | Southern Clay | Hydrophobic | — | — | Organic Clay |
| | Products, Inc | | | | |

TABLE 5

| | | | Number | | | |
|---|---|---|---|---|---|---|
| | | | of EO | | | |
| | Name of | Type of | Units in | Water | Viscosity | Viscosity |
| Name of Product | Manufacturer | Acrylate | Monomer | Solubility | (CPS/25° C.) | (Pa · S/25° C.) |
| Light-Ester4EG | Kyoeisha | Methacrylate | 4 | No | 15 | 0.015 |
| | Chemical Co., | | | | | |
| | Ltd | | | | | |
| Light-Ester9EG | Kyoeisha | Methacrylate | 9 | Yes | 35 | 0.035 |
| | Chemical Co., | | | | | |
| | Ltd | | | | | |
| Light-Ester14EG | Kyoeisha | Methacrylate | 14 | Yes | 64 | 0.064 |
| | Chemical Co., | | | | | |
| | Ltd | | | | | |
| New | Dai-Ichi | Acrylate | 6 | Yes | 32 | 0.032 |
| FrontierPE300 | Kogyo Seiyaku | | | | | |
| | Co., Ltd | | | | | |
| New | Dai-Ichi | Acrylate | 9 | Yes | 46 | 0.046 |
| FrontierPE400 | Kogyo Seiyaku | | | | | |
| | Co., Ltd | | | | | |
| SR9035 | Sartomer | Acrylate | 15 | Yes | 168 | 0.17 |
| | Company Inc | | | | | |
| SR415 | Sartomer | Acrylate | 20 | Yes | 225 | 0.23 |
| | Company Inc | | | | | |
| OTA480 | DAICEL- | Acrylate | — | No | 90 | 0.090 |
| | CYTEC | | | | | |
| | Company Ltd | | | | | |
| DPCA-60 | Nippon | Acrylate | — | No | 1350 | 1.35 |
| | Kayaku Co., | | | | | |
| | Ltd | | | | | |
| CN116 (Oligomer) | Sartomer | Acrylate | — | No | 2500 | 2.5 |
| | Company Inc | | | | | |

### (Evaluation)

Active energy beam-curable inks of Examples 1 to 24 and Comparative Examples 1 to 5 were evaluated as mentioned below in terms of separation resistance of ink components at high temperatures, film strength, ink flowability on two rolls, ink flowability upon high temperature storage, viscosity stability upon high temperature storage, and blocking. Tables 6 to 8 show the evaluation results.

Note that the degree of ink flow in a printer at a normally used temperature can be evaluated by the evaluation of “ink flowability on two rolls,” and the flowability of ink in a printer at a normally used temperature, which ink has been exposed to high temperatures, can be evaluated by the evaluation of “ink flowability upon high temperature storage.”

### <Evaluation of Separation Resistance at High Temperatures>

Each of the active energy beam-curable inks of Examples 1 to 24 and Comparative Examples 1 to 5 was put in a glass bottle. The glass bottle was sealed and left for a month at 60° C. Separation of ink components was visually evaluated based on the undermentioned evaluation criteria of three grades.

### —Evaluation Criteria—

A: Separation was hardly observed
B: Separation was hardly observed, but the ink can be practically used
C: Separation was significantly observed, and the ink cannot be practically used

### <Evaluation of Film Strength>

Images were printed by a stencil printer (SATELIO A650 manufactured by Ricoh Company Ltd) using the active energy beam-curable inks of Examples 1 to 24 and Comparative Examples 1 to 5. Thereafter, the images on printed sheets were rubbed with a piece of cloth, and a stain on the piece of cloth was visually evaluated based on the undermentioned evaluation criteria of three grades.

### —Evaluation Criteria—

A: Stain was hardly observed
B: Stain was slightly observed, but the ink can be practically used
C: Stain was significantly observed, and the ink cannot be practically used

### <Evaluation of Ink Flowability on Two Rolls>

The shape of each of the active energy beam-curable inks of Examples 1 to 24 and Comparative Examples 1 to 5, when placed on a roll (constituted by two rolls) for ink kneading in a printer at 23° C., was visually evaluated based on the undermentioned evaluation criteria of four grades.

### —Evaluation Criteria—

A: Changes were not observed
B: Changes were slightly observed, but the ink can be practically used
C: Shapes of ink clots changed from a kneaded state, but the ink can be practically used
D: The ink became flat and had fluidity, and the ink cannot be practically used

### <Ink Flowability After High Temperature Storage>

The active energy beam-curable inks of Examples 1 to 24 and Comparative Example 1 to 5 were stored for a month at 60° C. The flowability of each sample was visually evaluated based on the undermentioned evaluation criteria of three grades. Note that the temperature of the samples was 23° C. upon the evaluation.

### —Evaluation Criteria—

A: Flow was hardly observed
B: Flow was slightly observed, but the ink can be practically used
C: Flow was significantly observed, and the ink cannot be practically used

### <Viscosity Stability Upon High Temperature Storage>

The viscosities of the active energy beam-curable inks of Examples 1 to 24 and Comparative Examples 1 to 5 were measured by a stress rheometer (CSR-10 manufactured by Bohlin Instruments Ltd.) before the samples were stored and after the samples were stored for a month at 60° C. Specifically, a cone having a diameter of 2 cm and an angle of 2 degrees was used to measure a flow curve at 23° C. under a stress of 12.5 Pa to 150 Pa. Casson plastic viscosities and Casson yield values were calculated according to the undermentioned Casson's Approximation Formula. The viscosities upon the share rate of 10 s⁻¹ were obtained from the calculated values. These were taken as the viscosities of the samples.

Casson's Approximation Formula: \sqrt{τ}−\sqrt{τ₀}=\sqrt{Eta×D} Equation (2)

where τ represents a shear stress, τ₀ represents a yield value, Eta represents a plastic viscosity, and D represents a shear velocity.

The variations in the viscosities of the samples after storage with respect to those of the samples before storage were evaluated based on the undermentioned evaluation criteria of four grades.

### —Evaluation Criteria—

A: Increase in the viscosity was 20% or less, or a decrease in the viscosity was 15% or less
B: Increase in the viscosity was 20% or more, or a decrease in the viscosity was 15% or more, but the ink can be practically used
C: Increase in the viscosity was 40% or more, but the ink can be practically used
D: Increase in the viscosity was 60% or more, but the ink can be practically used

### <Plate Blocking>

First, 1000 sheets were printed by SATELIO A650 manufactured by Ricoh Company Ltd using the active energy beam-curable inks of Examples 1 to 24 and Comparative Examples 1 to 5. The surface of the plate was visually evaluated based on the undermentioned evaluation criteria of three grades.

### —Evaluation Criteria—

A: Blocking was not observed
B: Blocking was slightly observed, but the ink can be practically used
C: Blocking was observed, and the ink cannot be practically used

TABLE 6

| | Com. | Com. | Com. | Com. | Com. | | | | | | |
|---|---|---|---|---|---|---|---|---|---|---|---|
| | Ex. 1 | Ex. 2 | Ex. 3 | Ex. 4 | Ex. 5 | Ex. 1 | Ex. 2 | Ex. 3 | Ex. 4 | Ex. 5 | Ex. 6 |
| Separation Resistance At | B | C | A | C | C | B | A | A | A | A | A |
| High Temperatures | | | | | | | | | | | |
| Film Strength | A | A | C | A | A | A | A | A | A | A | A |
| Ink Flowability on Two | D | A | C | A | D | A | A | A | B | C | C |
| Rolls | | | | | | | | | | | |
| Ink Flowability Upon High | C | A | C | A | C | B | B | B | B | B | B |
| Temperature Storage | | | | | | | | | | | |
| Viscosity Stability Upon | B | C | C | B | C | C | C | C | C | C | C |
| High Temperatute Storage | | | | | | | | | | | |
| Blocking | A | C | C | C | C | B | A | A | A | A | A |

TABLE 7

| | Ex. 7 | Ex. 8 | Ex. 9 | Ex. 10 | Ex. 11 | Ex. 12 | Ex. 13 | Ex. 14 |
|---|---|---|---|---|---|---|---|---|
| Separation Resistance At | A | A | A | A | A | A | A | A |
| High Temperatures | | | | | | | | |
| Film Strength | A | A | A | A | A | A | A | A |
| Ink Flowability on Two Rolls | A | A | A | A | A | A | A | B |
| Ink Flowability Upon High | A | A | A | A | A | A | A | A |
| Temperature Storage | | | | | | | | |
| Viscosity Stability Upon | B | A | A | A | C | A | A | A |
| High Temperatute Storage | | | | | | | | |
| Blocking | A | A | A | A | A | A | A | A |

TABLE 8

| | Ex. 15 | Ex. 16 | Ex. 17 | Ex. 18 | Ex. 19 | Ex. 20 | Ex. 21 | Ex. 22 | Ex. 23 | Ex. 24 |
|---|---|---|---|---|---|---|---|---|---|---|
| Separation Resistance At | A | B | A | A | A | A | A | A | A | A |
| High Temperatures | | | | | | | | | | |
| Film Strength | A | A | A | A | A | A | A | A | A | A |
| Ink Flowability on Two | A | A | B | A | A | A | A | A | A | A |
| Rolls | | | | | | | | | | |
| Ink Flowability Upon High | A | A | B | A | A | A | A | A | A | A |
| Temperature Storage | | | | | | | | | | |
| Viscosity Stability Upon | A | A | C | A | A | A | A | A | A | B |
| High Temperatute Storage | | | | | | | | | | |
| Blocking | A | A | A | A | A | A | A | A | A | A |

Results shown in Tables 6 to 8 indicate the following matters.

Comparing Examples 1 to 6 with Comparative Examples 1, 2, and 4, the separation resistance at high temperatures was enhanced by adding hydrophilic silica serving as the extending pigment.

Comparing Examples 1 to 6 with Comparative Examples 3 and 5, it is possible to give film strength, to further prevent ink flow on the two rolls (ink flow that occurs in a printer at a normally used temperature), and to further prevent ink flow at high temperatures, when the primary particle diameter of the hydrophilic silica is 100 nm or less.

Comparing Example 4 with Examples 5 and 6, it is possible to further prevent ink flow the two rolls when the specific surface of the hydrophilic silica is 280 m²/g or less.

Comparing Examples 2 and 3 with Examples 1, 4, and 17, it is possible to enhance the separation resistance at high temperatures, to further prevent ink flow on the two rolls, and to further prevent the blocking, when the hydrophilic silica has a primary particle diameter of 28 nm or less and a specific surface of 190 m² or less.

Comparing Examples 7 to 10, 18, and 20 to 24 with Example 3, it is possible to further prevent ink flow at high temperatures and further enhance the viscosity stability upon high temperature storage, when the ink contains a monomer having ethylene oxide units serving as a polymerizable component.

Comparing Examples 8, 12, 13, and 19 with Examples 11 and 14, it is possible to further prevent ink flow on the two rolls and to further prevent ink flow at high temperatures, when the number of ethylene oxide units is 6 to 19.

Comparing Examples 22 and 23 with Examples 7 and 24, it is possible to further enhance the viscosity stability upon high temperature storage, when the amount of monomer having ethylene oxides is 0.02% by mass to 20% by mass with respect to the total mass of the ink.

Comparing Example 15 with Example 16, it is possible to further enhance the separation resistance at high temperatures, when the amount of water is 5% by mass or less with respect to the total mass of the ink.

The active energy beam-curable ink of the present invention is capable of preventing ink flow by enhancing the separation resistance of ink components at high temperatures without impairing the stability against viscosity changes due to high temperatures. Therefore, the ink is very useful when the ink is used for a printer, for example, in an office without a full-time operator.

What is claimed is:

1. An active energy beam-curable ink comprising:
hydrophilic silica with a primary particle diameter of 100 nm or less.

2. The active energy beam-curable ink according to claim 1, wherein a specific surface of the hydrophilic silica is 280 m²/g or less.

3. The active energy beam-curable ink according to claim 1, wherein the hydrophilic silica has a primary particle diameter of 28 nm or less and a specific surface of 190 m²/g or less.

4. The active energy beam-curable ink according to claim 1, further comprising:
a monomer comprising an ethylene oxide unit represented by Structural Formula (1).
—CH₂CH₂O)— Structural Formula (1)

5. The active energy beam-curable ink according to claim 4, wherein in the monomer the number of the ethylene oxide unit represented by Structural Formula (1) is 6 to 19.

6. The active energy beam-curable ink according to claim 4, wherein an amount of the monomer comprising the ethylene oxide unit represented by Structural Formula (1) is 0.02% by mass to 20% by mass with respect to a total mass of the ink.

7. The active energy beam-curable ink according to claim 1, wherein an amount of water is 5% by mass or less with respect to a total amount of the ink.

8. The active energy beam-curable ink according to claim 1, wherein the ink is used for stencil printing in which an image is formed by the ink passed through holes of a stencil perforated by thermal digital plate making.

9. The active energy beam-curable ink according to claim 1, wherein when the ink comprises a monomer comprising an ethylene oxide unit, the monomer is a methacrylate monomer
